(19) United States
(12) Patent Application Publication
(10) Pub. No.: US 2011/0271074 A1
(43) Pub. Date: Nov. 3, 2011

(54) Method for memory management to reduce memory fragments

(76) Inventor: Youngki Lyu, Suwon-si (KR)

(21) Appl. No.: 13/097,774

(22) Filed: Apr. 29, 2011

(30) Foreign Application Priority Data
Apr. 30, 2010 (KR) 10-2010-0040924

(51) Int. Cl. G06F 12/02

(52) U.S. Cl. 711/173; 711/170; 711/E12.002

(57) ABSTRACT

Provided is a method and apparatus for managing a memory. The method and apparatus may allocate or release a memory larger than N bytes through a heap; and the performance of allocating or releasing a memory smaller than or equal to N bytes through a fragless module, wherein the memory smaller than or equal to N bytes is allocated or released at a first region of a memory pool without passing through the heap.

### CROSS-REFERENCE TO RELATED APPLICATIONS

This U.S. non-provisional patent application claims priority under 35 U.S.C. §119 of Korean Patent Application No. 10-2010-0040924, filed on Apr. 30, 2010, the entire contents of which are hereby incorporated by reference.

### BACKGROUND

A method for memory management is described, and more particularly, a method of memory management to reduce or eliminate memory fragments, thereby eliminating the requirement to specifically perform memory garbage collection in order to clean up memory fragments.

Embedded systems are already being used in high technology mobile systems such as mobile computers, multimedia handheld personal digital assistants, digital cameras, broadband communication devices and some precision instruments.

With the recent improvements to multimedia and network technologies, the embedded systems within these technologies are becoming more and more complex. As the structure and performance of the embedded systems become more complex, the Operating Systems (OS) used in these technologies are also becoming more complex. Also, since most of the embedded systems require characteristics of ‘real-time processing’, a Real-Time Operating System (RTOS) may be used in the embedded systems.

Since the RTOS must have a simpler structure in comparison to a general OS used for a general purpose computer system, an RTOS is applied to the embedded systems of these high technology mobile systems. For instance, the RTOS is applied to various embedded systems such as mobile communication devices such as cell phones, smart phones, PDAs, wireless internet devices, and car navigation systems, and mobile devices for providing particular functions such as sales, business development and inventory management.

Since the embedded systems installed with the RTOS may have a small amount of memory, it may be important to use the memory as efficiently as possible. The RTOS, for the most part, adopts a method of dynamic memory allocation for efficient memory management; however, time determinacy, which is an important factor of the RTOS, is partly degraded, and resources are unnecessarily used for the memory management. In order to efficiently management the memory resources within these embedded systems, a method of memory management is used for the RTOS in order to reduce or prevent memory fragments.

FIG. 1 is a diagram for explaining an allocation of memory into allocated memory 40 and also a release of memory to available free memory 30 within a memory pool 10.

Referring to FIG. 1, the memory pool 10 is a memory region used for dynamic memory allocation in the embedded system. The memory pool 10 is also called a heap memory or a heap area. A memory of the memory pool 10 may be allocated or released by control of a manager called a heap. However, in the case that memories of various sizes are frequently allocated and released in the operating system not provided with a function of garbage collection such as in a RTOS, free memories 30 may be fragmented to various sizes at various positions of the memory pool 10 as illustrated in FIG. 1.

In the case of FIG. 1, even if the total size of the combined free memories 30 in the memory pool 10 is larger than that of a memory requirement 20 which is to be allocated, the memory requirement 20 may not be allocated due to the fragmentation of the free memory 30 in the memory pool 10.

### SUMMARY

The disclosed embodiments provide a method of memory management capable of reducing and/or preventing memory fragmentation in a memory pool in an operating system environment, even where a garbage collection function may not be provided.

According to one embodiment, the method of memory management is capable of efficiently using limited resources of an embedded system.

In another embodiment, the method of memory management performs allocation or release operations for a memory larger than N bytes through a heap; and performs allocation or free operations for a memory smaller than or equal to N bytes through a fragless module, wherein the memory smaller than or equal to N bytes may be allocated or released at a first region of a memory pool without passing through the heap.

In another embodiment, the memory larger than N bytes may be allocated or released at a second region of the memory pool through a heap.

In another embodiment, the allocation or release operations for the memory smaller than or equal to N bytes may include the following: selecting a fragment section among a plurality of fragment sections based on the size of the requested memory; determining a size of a memory fragment as a maximum value of the fragment section where the requested memory is included; allocating a first chunk having a size which is M times larger than the determined memory fragment size; and allocating the memory fragment corresponding to the requested memory within the first chunk.

According to one embodiment, the fragment sections may be divided to have different sizes within range of N bytes.

In yet another embodiment, the first chunk may include M numbers of memory fragments.

In another embodiment, the method may further include allocating a second chunk in the case that there exists no empty memory fragment space within the first chunk.

According to one embodiment, the second chunk may be larger than or equal to the first chunk.

In another embodiment, a size of the second chunk may be determined based on at least one of the number of times of previously performed chunk allocation operations, the number of times of previously performed chunk free operations, and a chunk weight.

According to one embodiment, the chunk weight may be increased when the second chunk is allocated or when the second chunk is successively allocated more than a predetermined number times.

According to one embodiment, the first and second chunks may be included in a chunk list.

In another embodiment, the second chunk may be configured to be at the highest position of the chunk list.

According to one embodiment, for the memory fragment corresponding to the requested memory, the memory fragment of the second chunk configured to be on the highest position of the chunk list may be allocated first.

In another embodiment, the allocation or free operation for the memory smaller than or equal to N bytes may include erasing flag information of a memory fragment corresponding to a memory requested to be released if the memory smaller than or equal to N bytes is requested to be released; determining whether an empty chunk is configured to be on the highest position of a chunk list if the chunk where the memory fragment whose flag information is erased happens to be empty; releasing the empty chunk from the chunk list if the empty chunk is not configured to be on the highest position of the chunk list according to a result of the determination; and increasing a chunk weight.

According to one embodiment, the flag information may be stored in a header of the chunk where the memory fragment whose erased flag information is included.

In yet another embodiment, the method may further include maintaining the empty chunk on the chunk list if the empty chunk is configured to be on the highest position of the chunk list according to the result of the determination.

According to one embodiment, the chunk weight may be increased when the empty chunk is released from the chunk list or when the empty chunk is successively released from the chunk list more than the predetermined number of times.

In another embodiment, methods for managing a memory to include determining what fragment section among a plurality of fragment sections based on the size of a requested memory to be allocated if the memory smaller than or equal to N bytes is requested to be allocated through a fragless module; determining a size of a memory fragment as a maximum value of the fragment section where the requested memory is included; allocating a first chunk having a size which is M times larger than the determined memory fragment size at one region of a memory pool; and allocating the memory fragment corresponding to the requested memory within the first chunk.

In another embodiment, the fragment sections may be divided to have different sizes within range of N bytes, and the first chunk may include M numbers of memory fragments.

In another embodiment, the method may further include allocating a second chunk larger than or equal to the first chunk in the case that there exists no empty memory fragment within the first chunk.

According to one embodiment, methods for managing a memory include erasing flag information of a memory fragment corresponding to a requested memory to be released if the memory smaller than or equal to N bytes is requested to be released through a fragless module; determining whether an empty chunk is configured to be on a highest position of a chunk list if the chunk where the memory fragment whose flag information is erased happens to be empty; releasing the empty chunk from the chunk list if the empty chunk is not configured to be on the highest position of the chunk list according to a result of the determination; and increasing a chunk weight, wherein the chunk weight is used for determining a size of a new chunk, and the chunk is allocated and released within one region of a memory pool.

### BRIEF DESCRIPTION OF THE DRAWINGS

Exemplary embodiments will be more clearly understood from the following detailed description taken in conjunction with the accompanying drawings:

FIG. 1 is a diagram for explaining an allocation operation and a release operation of a memory pool 10;

FIG. 2 is a diagram illustrating a user device 1000 with a method of memory management;

FIG. 3 is a diagram illustrating a detailed structure of the memory 1200 illustrated in FIG. 2;

FIG. 4 is a diagram illustrating the memory management method performed by a fragless module 200 and a heap 300;

FIG. 5 is a diagram illustrating a processing unit of the memory allocation and release operation performed by the fragless module;

FIG. 6 is a diagram illustrating a method for configuring a chunk list;

FIG. 7 is a diagram illustrating a method for configuring the chunk list;

FIG. 8 is a diagram illustrating configuration of the chunk;

FIG. 9 is a diagram illustrating an arrangement form of the chunk illustrated in FIG. 8 on the chunk list;

FIG. 10 is a flowchart illustrating a method for releasing memory;

FIG. 11 is a flowchart illustrating the method of memory allocation;

FIG. 12 is a diagram for explaining the memory allocation and release;

FIG. 13 is a diagram illustrating a convergence process of the memory pool according to memory allocation and release;

FIG. 14 is a diagram illustrating a speed of the convergence of the memory pool according to the chunk weight value;

FIG. 15 is a diagram illustrating the number of times of memory allocation call and a corresponding amount of required memory which are possibly generated at the time of horizontal scroll;

FIG. 16 is a diagram illustrating a user device 2000; and

FIG. 17 is a user device 3000 incorporating an embodiment of the memory management apparatus.

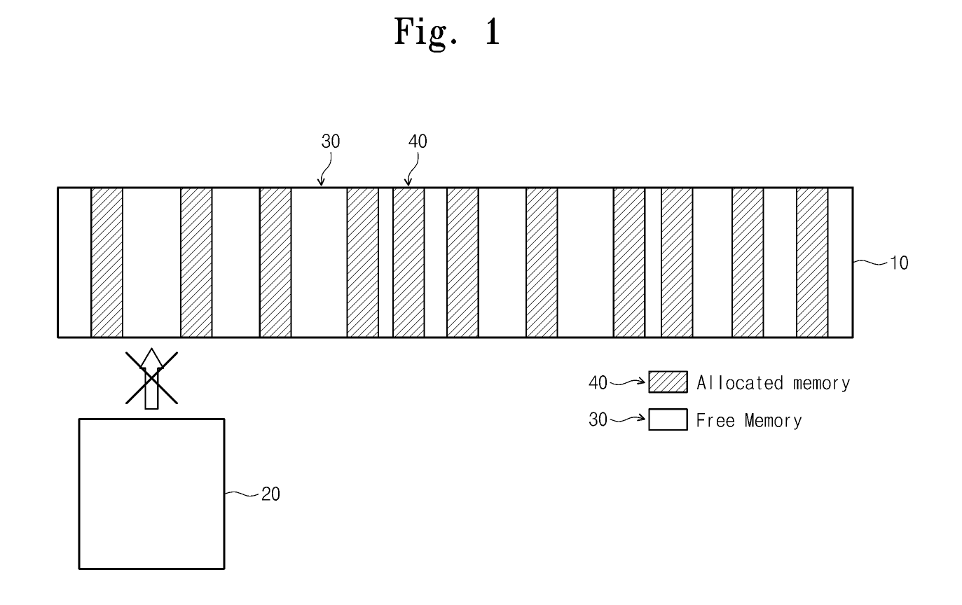

### DETAILED DESCRIPTION

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. This invention, however, may be embodied in many alternate forms and should not be construed as limited to only example embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two steps or figures shown in succession may in fact be executed substantially concurrently or may sometimes be executed in the reverse order, depending upon the functionality/acts involved.

In order to more specifically describe example embodiments, various aspects will be described in detail with reference to the attached drawings. However, the present invention is not limited to example embodiments described.

In the drawings, the dimensions of layers and regions are exaggerated for clarity of illustration.

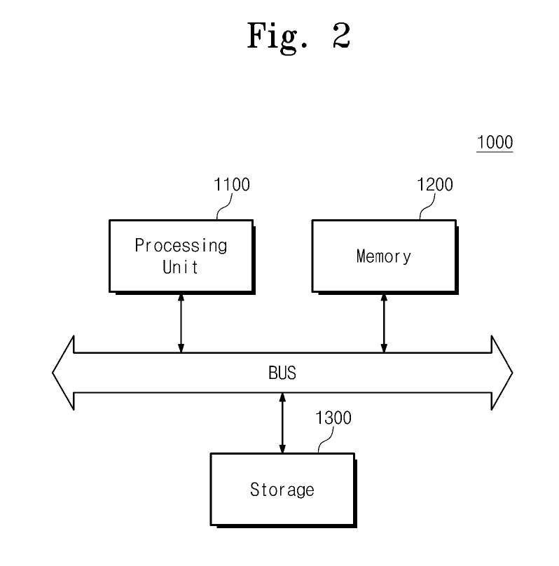

FIG. 2 is a diagram illustrating a user device 1000 which uses a method of memory management.

Referring to FIG. 2, the user device 1000 may include a processing unit 1100, a memory 1200, and a storage device 1300.

In one embodiment, the user device 1000 may be structured as an embedded system. The user device 1000 may be applicable to portable computers, Ultra Mobile PCs (UMPCs), workstations, net-books, personal digital assistant (PDAs), web tablets, wireless phones, mobile phones, smart phones, digital cameras, digital audio recorders, digital audio players, digital picture recorders, digital picture players, digital video recorders, digital video players, devices capable of transmitting/receiving information in wireless environments, and one of various electronic devices constituting a home network. Also, a Real-Time Operating System (RTOS) or a mobile OS may be applied to the user device 1000 for light-weight and high operating speed of a system.

Although it will be explained in detail below, the user device 1000 may provide the method of memory management capable of preventing or reducing memory fragments in an OS environment where a garbage collection function may not be supported, e.g., an RTOS or a mobile OS where the garbage collection function may not be supported. According to the method of memory management, limited resources of the embedded system may be efficiently used.

The processing unit 1100 may be configured to control read, write and erase operations of the memory 1200 and the storage device 1300 through a bus. The processing unit 1100 may include a commercially usable or customized microprocessor, a Central Processing Unit (CPU) and the like.

The memory 1200 may be one or more general-purpose memory devices containing software or data for operating the user device 1000. Also, the memory 1200 may be used for data transfer between the processing unit 1100 and the storage device 1300. For instance, the memory 1200 may be operated as a buffer for temporarily storing data to be written to the storage data 1300 or data read from the storage device 1300 by request of the processing unit 1100. Also, one or a plurality of memories may be included in the memory 1200. In this case, each memory may be used as a write buffer, a read buffer, or a buffer having both functions of read and write. The memory 1200 is not limited to a particular type but may be implemented in a variety of ways. For instance, the memory 1200 may be implemented with a high speed volatile memory such as a DRAM or an SRAM, or a nonvolatile memory such as an MRAM, a PRAM, an FRAM, a NAND flash memory, or a NOR flash memory. According to the embodiments, the memory 1200 is exemplarily implemented with DRAM or SRAM.

The storage device 1300 may be integrated in one semiconductor device so as to construct a PC card (PCMCIA, personal computer memory card international association), a Compact Flash (CF) card, a Smart Media Card (SM, SMC), a memory stick, a Multimedia Card (MMC, RS-MMC, MMC-micro), and SD card (SD, mini-SD, micro-SD, SDHC), and a Universal Flash Storage (UFS) or construct a semiconductor disk (Solid State Disk or Solid State Drive, SSD). The storage device 1300 is not limited to a particular form but may be implemented as various forms.

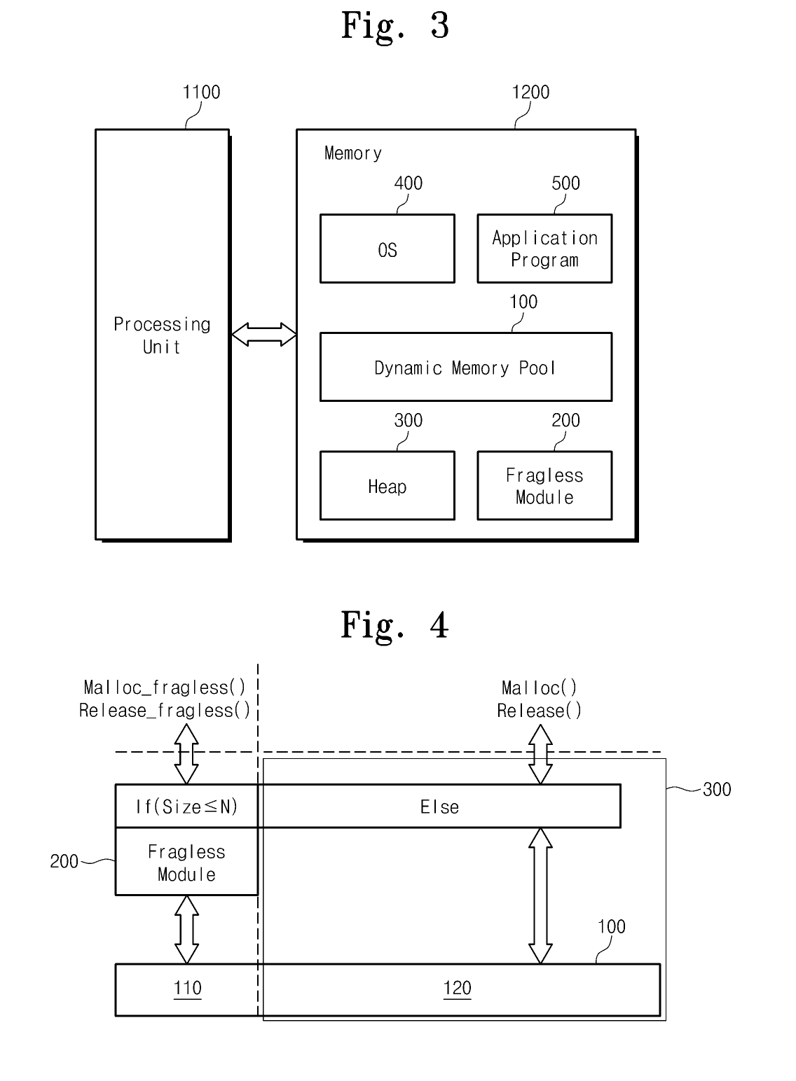

FIG. 3 is a diagram illustrating a detailed example structure of the memory 1200 illustrated in FIG. 2. FIG. 4 is a diagram illustrating an example of a memory management method performed by a fragless module 200 and a heap 300.

The memory 1200 may be structured with an OS 400 and an application program 500 for operating the user device 1000, and one or more general-purpose memory devices for storing data.

The Operating System (OS) 400 may be implemented with a RTOS or mobile OS. For instance, the RTOS may include VxWorks (www.windriver.com), pSOS (www.windriver.com), VRTX (www.mento.com), QNX (www.qnx.com), OSE (www.ose.com), Nucleus (www.atinucleus.com), and MC/OSII (www.mcos-ii.com). The mobile OS may include Symbian OS, Windows Mobile, MAC OS, JAVA OS, JAVA FX Mobile, Linux, SaveJe, and BADA. The OS 400 according to the disclosed embodiments is not limited to a particular from of OS but may be implemented as various forms. Although it will be explained in detail below, the user device 1000 may prevent fragments of a memory pool 100 through the fragless module 200 even if the OS 400 does not provide the garbage collection function. Accordingly, limited resources of the embedded system within user device 1000 may be efficiently used.

The data used by the OS 400 and/or the application program 500 may be allotted to the memory pool 100. A memory allocation/release operation for the memory pool 100 may be performed by the fragless module 200 and the heap 300.

Referring to FIG. 4, the memory pool 100 may be structured with a dynamic memory pool. The fragless module 200 and the heap 300 may perform the memory allocation and release operation for the memory pool 100. For instance, the fragless module 200 and the heap 300 may allocate a memory requested by the application program 500 in the memory pool 100, and the allocated memory may be provided to the application program 500. And, the memory that the application program 500 has finished using (i.e., memory released) may be converted to free memory by cancelling the allocation in the memory pool 100.

In one embodiment, the memory pool 100 may be divided into a first region 110 where the memory allocation and release operations are performed by the fragless module 200, and a second region 120 where the memory allocation and release operations are performed by the heap 300.

For instance, the heap 300 may be configured to allocate and release memory larger than a predetermined size (e.g., N bytes) within the second region 120. And, the fragless module 200 may be configured to allocate and release memory which is equal to or smaller than the predetermined size (e.g., N bytes) within the first region 110. According to the described embodiments, it will be described that the fragless module 200 allocates and releases memory which is equal to or smaller than 32,768 bytes. Herein, the size of memory allocation and memory release applicable to the fragless module 200 and the heap 300 is not limited to a particular value but may be variously changed and modified.

For the memory allocation operation performed by the heap 300, a function of ‘malloc ( )’ may be used. For the memory release operation performed by the heap 300, a function of ‘release ( )’ may be used. According to the memory allocation and release operation performed by the heap 300, memory which is larger than N bytes (e.g., 32,768 bytes) may be allocated and released within the second region 120 of the memory pool 100. For the memory allocation operation performed by the fragless module 200, a function of ‘malloc_fragless ( )’ may be used. For the memory release operation performed by the fragless module 200, a function of ‘release_fragless ( )’ may be used. According to the memory allocation and release operation performed by the fragless module 200, memory which is equal to or smaller than N bytes (e.g., 32,768 bytes) may be allocated and released on the first region 110 of the memory pool 100.

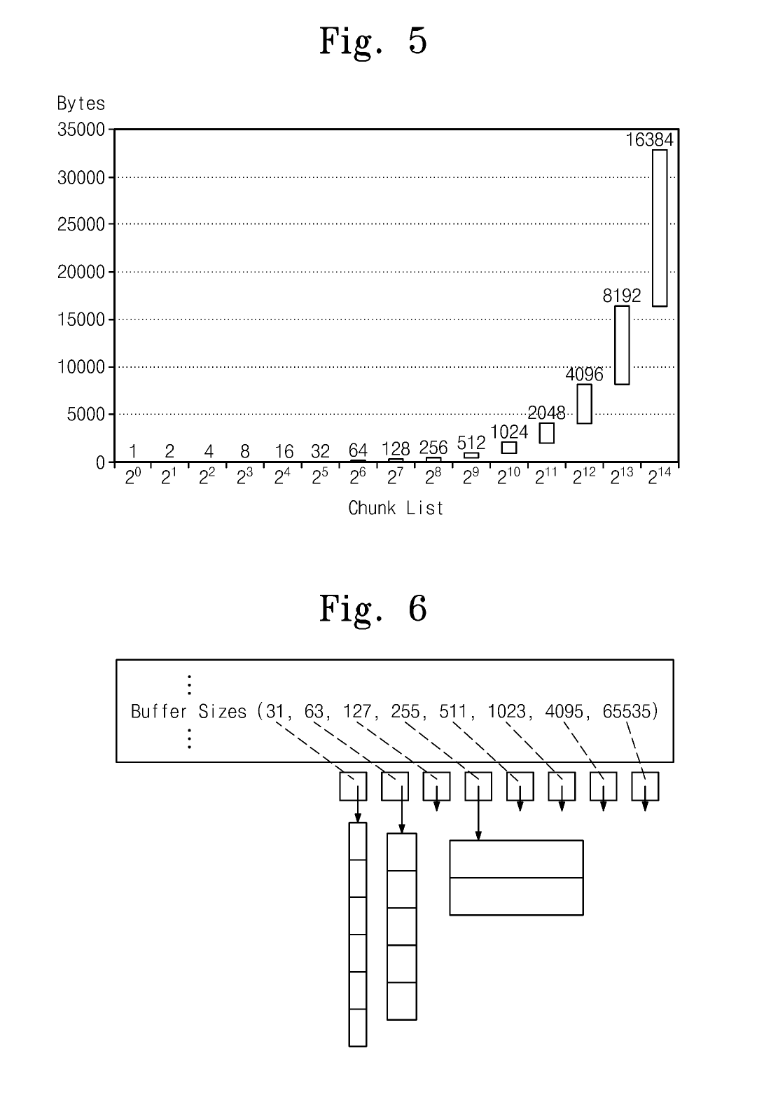

According to the above-described configuration, a small-sized memory allocation requested by the application program 500 may be internally performed within the first region 110 through the fragless module 200 without process of the heap 300. As a result, the allocation and release of memory smaller than the predetermined size (e.g., N bytes) does not occur in the memory pool 100 except within the first region 110, and thus fragmentation of the memory pool 100 is prevented. The memory management method performed by the fragless module 200 will be explained in detail referring to FIGS. 5 to 15.

FIG. 5 is a diagram illustrating the number of bytes and the corresponding chunk list.

Referring to FIG. 5, the memory requested by the application program 500 may be divided into a plurality of fragment sections according to size of the requested memory. According to what section the requested memory belongs to among the fragment sections, the size of the fragment memory and the chunk to be used for allocating the requested memory may be determined. The size of chunk corresponding to each fragment section is illustrated in FIG. 5.

For instance, in the case that 200 bytes of memory are requested to be allocated, it may be determined that 200 bytes belong to a fragment section which is larger than 2⁷ (i.e., 128) and equal to or smaller than 2⁸ (i.e., 256). In this case, if the memory included in the fragment section (e.g., 200 bytes of memory) is requested to be allocated, the size (nₓ) of memory to be allocated (hereinafter, referred to as fragment memory) may be determined as the maximum value (i.e., 256) in the fragment section, and the chunk including a plurality of fragment memories with the determined size (nₓ) may be determined.

The fragless module 200 may allocate and release the memory requested by the application program 500 within the chunk. Each chunk may be provided with M (e.g., 32) fragment memories each of which has a predetermined size (nₓ). Accordingly, each chunk may be configured to have a size M times larger than the fragment memory size (nₓ) corresponding to the requested memory (i.e., nₓ×M). The chunk may be managed as a chunk list form, and each chunk size is not limited to a particular value but may be variously changed.

FIG. 6 is a diagram illustrating a method for configuring the chunk list according to a first disclosed embodiment.

Referring to FIG. 6, according to the size of memory requested by the application program 500, the fragless module 200 may determine the size of fragment memory (nₓ) to be allocated in the first region 110 of the memory pool 100. Then, the chunk corresponding to the determined fragment memory size (nₓ) may be determined. The memory requested by the application program 500 may be allocated within the determined chunk.

The chunks corresponding to each fragment section illustrated in FIG. 5 may constitute the chunk list as illustrated in FIG. 6. If the chunk corresponding to the determined fragment memory size (nₓ) does not exist in the corresponding chunk list (i.e., the chunk list is in a NULL state), a first chunk may be allocated to the corresponding chunk list. Then, the memory requested by the application program 500 may be allocated within the first chunk.

Also, in the case that the chunk corresponding to the determined fragment memory size (nₓ) exists in the corresponding chunk list but there is no empty space in a selected chunk, a new chunk may be additionally allocated to the chunk list. Then, the memory requested by the application program 500 may be allocated within the additionally allocated chunk.

The additionally allocated chunk may be configured to have the same size as a previously allocated chunk in the chunk list as illustrated in FIG. 6. The chunk list configuration according to a first disclosed embodiment may correspond to the case of not applying a chunk weight. However, the size of the chunk is not limited to a particular value but variously changeable.

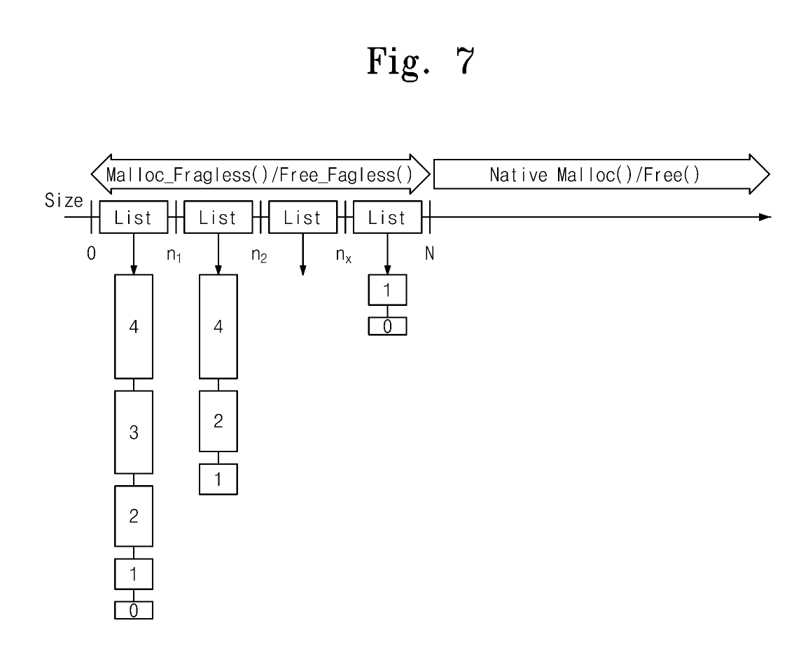

FIG. 7 is a diagram illustrating a method for configuring the chunk list according to another embodiment.

Referring to FIG. 7, for configuring the chunk list, it may be previously determined to what memory size (e.g., N bytes) the fragmentation is allowed. For instance, in the case that the heap 300 allows the fragmentation for the memory of up to 32,768 bytes, the allocation and release operation for the memory smaller than or equal to 32,768 bytes may be performed through the fragless module 200 instead of the heap 300. In this case, the heap 300 may perform the memory allocation and release operation for the memory larger than N bytes (e.g., 32,768 bytes) using the malloc ( ) and release ( ) functions. The memory allocation and release operation by the heap 300 may be performed within the second region 120 of the memory pool 100. The fragless module 200 may perform the memory allocation and release operation for the memory smaller than or equal to N bytes (e.g., 32,768 bytes) using the malloc_fragless ( ) and release_fragless ( ) functions. The memory allocation and release operation by the fragless module 200 may be performed within the first region 110 of the memory pool 100.

For the memory allocation and release operation to be performed by the fragless module 200, the fragment memory size (nₓ) to be allocated to the first region 110 of the memory pool 100 may be further determined within the range of the determined N bytes. The fragment memory size (nₓ) may indicate the data size within N bytes of the first region 110 of the memory pool 100 and how that data size may be divided. If the fragment memory size (nₓ) is determined, the chunk corresponding to the determined fragment memory size (nₓ) may be determined. The memory requested to be allocated by the application program 500 may be allocated within the chunk with the fragment memory size (nₓ) as a unit.

In one embodiment, the chunks allocated to the same list may be configured to have different sizes. And, among the chunks allocated to the same list, a later allocated chunk may be configured to be larger than or the same as a previously allocated chunk. In this case, the last allocated chunk may be linked to a first position of the corresponding list. And, the first allocated chunk may be linked to a last position of the corresponding list. As a result, among the chunks allocated to the corresponding list, the largest chunk may be linked to the first position and the smallest chunk may be linked to the last position. According to this configuration of the chunk list, when the application program 500 requests the memory allocation, a high chunk (i.e., a large-sized chunk) may be allocated first by the memory.

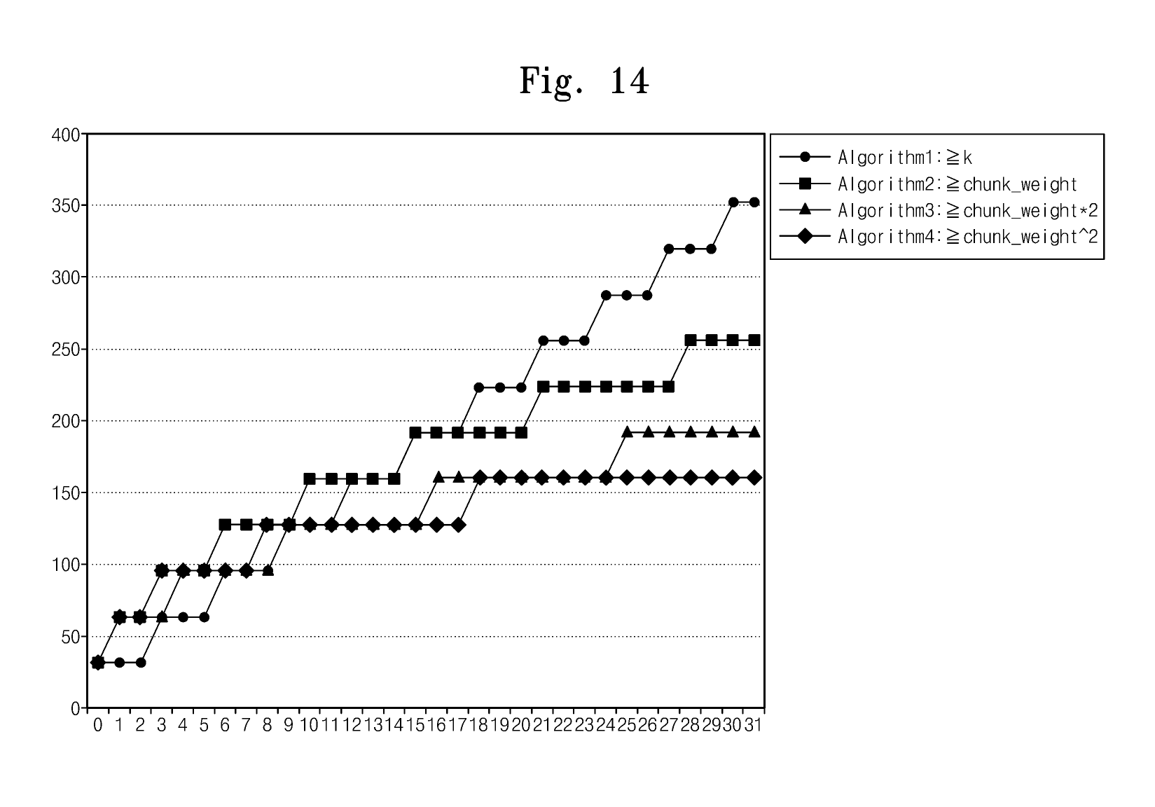

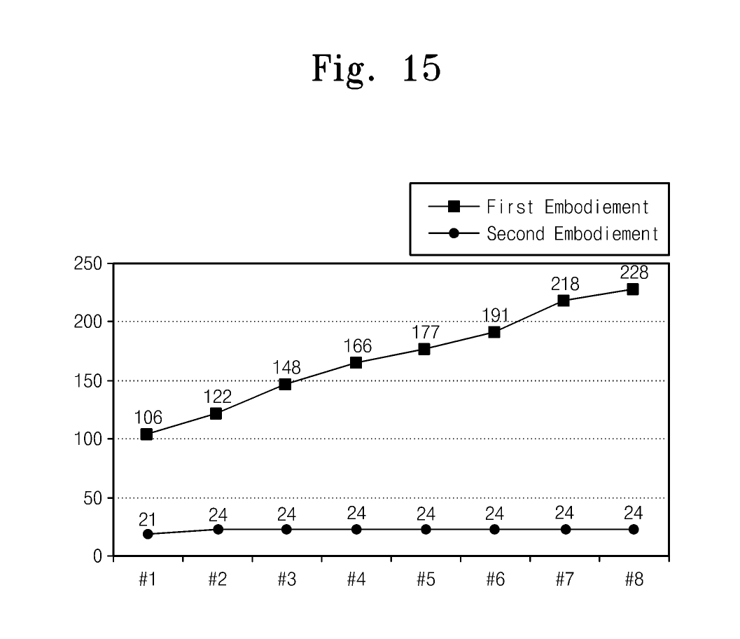

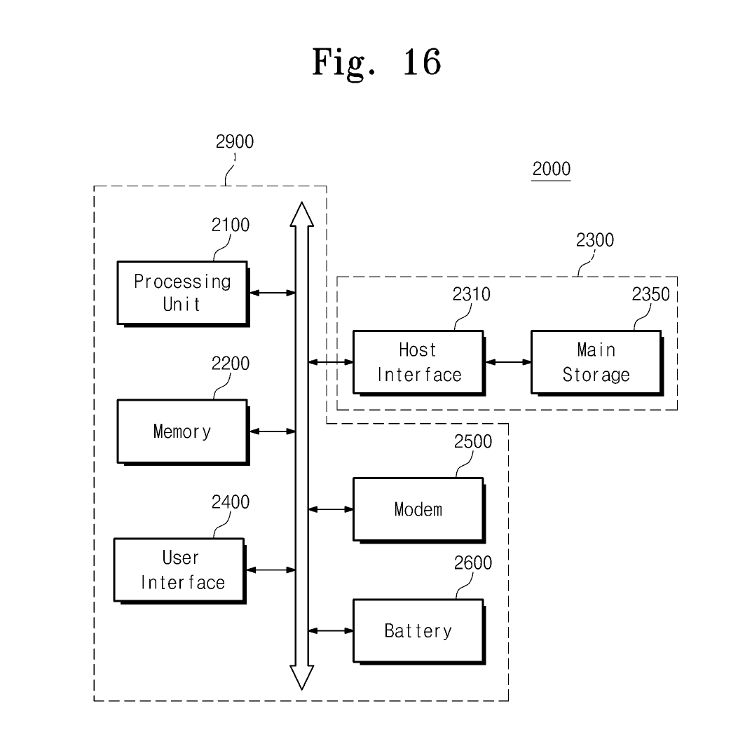

Additionally, a size of newly allocated chunk may be changed according to how many times the chunk allocation operation has been previously performed, how many times the chunk release operation has been previously performed, whether the chunk weight is applied, and a method of configuring the chunk weight. According to the chunk weight configuration method, the size of the memory allocated in the memory pool 100 may converge to the fragment memory size (nₓ) of a predetermined size. The convergence characteristics of the memory pool 100 will be explained in detail referring to FIGS. 14 and 15.

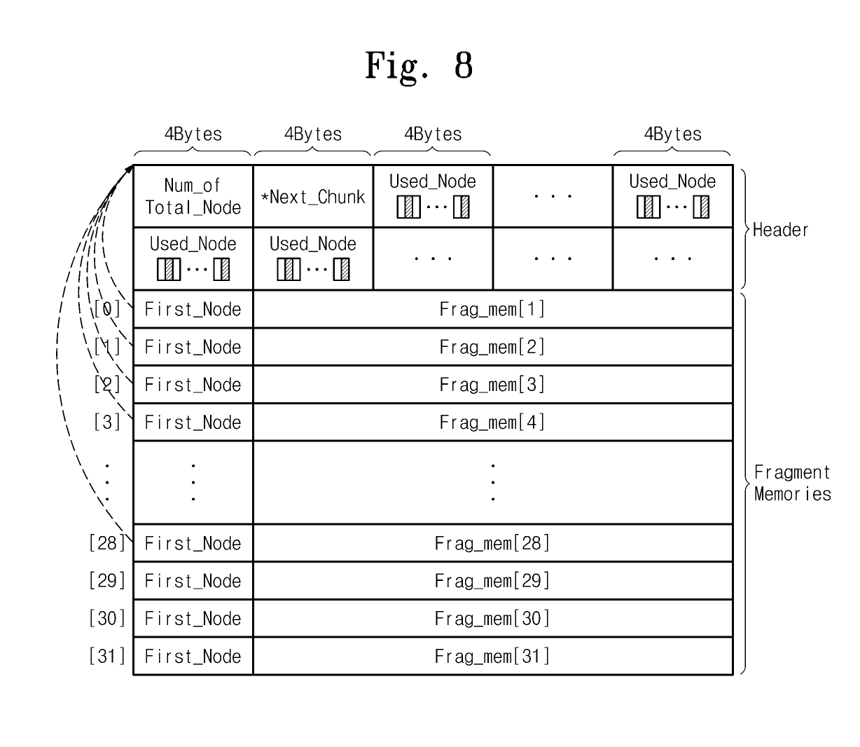

FIG. 8 is a diagram illustrating the configuration of the chunk.

Referring to FIG. 8, the chunk may be roughly divided into a header region and memory fragments region.

The chunk list information and used/unused information of a plurality of memory fragments included in the chunk may be stored into the header region. According to one embodiment, a total node information num_of_total_node, a next chunk address information *next_chunk, a memory fragment used/unused information used_node may be stored into the header region. The total node information num_of_total_node may be configured to indicate how many nodes are included in the corresponding chunk. The next chunk address information *next_chunk may be configured to point to the next chunk of the corresponding chunk on the chunk list. In the example, the next chunk address information *next_chunk may be configured as a pointer. The memory fragment used/unused information used_node may be stored as a flag according to whether the memory fragments included in the corresponding chunk are allocated or released.

According to one embodiment, each of the total node information num_of_total_node, the next chunk address information *next_chunk, and the memory fragment used/unused information used_node may be configured to have 4 bytes (i.e., 32 bits).

M (e.g., 32) nodes may be included in the memory fragments region. Each node may include a field of first node information first_node and a field of memory fragment frag_mem[i]. The field of first node information first_node may be configured to point to the position of a first node among a plurality (e.g., 32) of nodes provided to the corresponding chunk. According to this configuration, the first node of the corresponding chunk may be easily identified.

The field of memory fragment frag_mem[i] is a region where the memory requested by the application program 500 is substantially allocated. A size of each memory fragment frag_mem[i] may be defined as nₓ. For instance, in the case that 200 bytes of memory is requested to be allocated by the application program 500, the maximum value, i.e., 256 bytes, at the fragment section (e.g., fragment section of 129 to 256) in which the 200 bytes of memory is included may be defined as the memory fragment size nₓ. In the case that M (e.g., 32) nodes are configured for the corresponding chunk, memory of 256 bytes×32 in total may be allocated to the corresponding chunk. Allocated or released node information may be stored into a header field of the used/unused information used_node of memory fragments.

Besides, although not illustrated in FIG. 8, into a part ahead of a field of the total node information num_of_total_node as much as predetermined bytes (e.g., 4 bytes), the information pointing to a first chunk of the list where the corresponding chunk is included may be stored. According to such configuration, the first chunk of the list where each chunk is included may be easily identified.

The above-described configuration of the header region and the memory fragments region of the chunk is an example for the case of configuring the embedded system as a 32-bit system. Therefore, the size or number of bits of the field constructing the header and memory fragments regions may be changed and are not limited to the embodiments herein described.

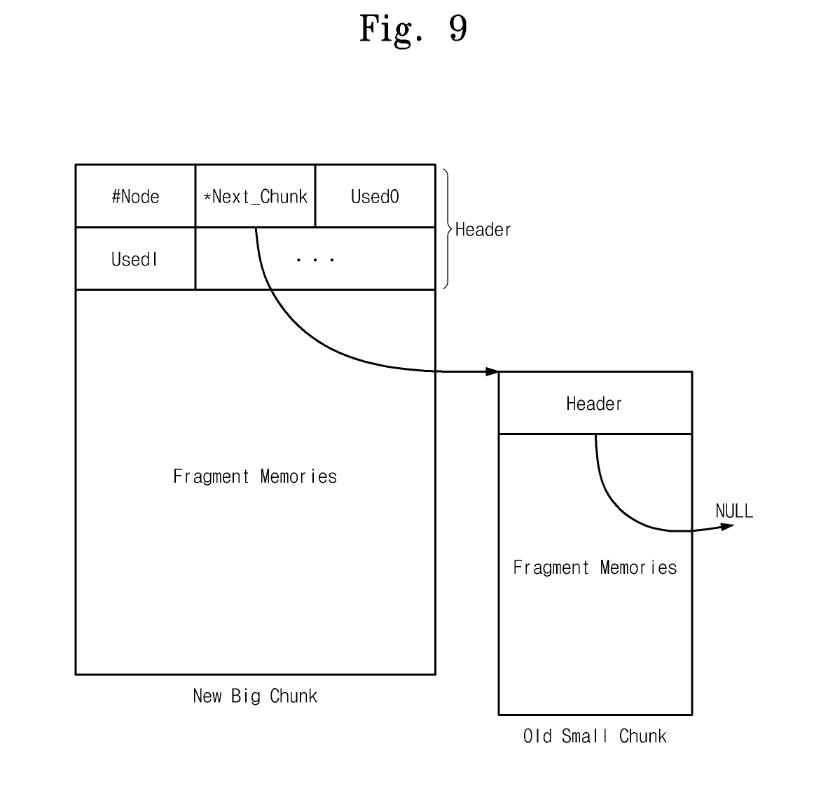

FIG. 9 is a diagram illustrating an example of the chunk illustrated in FIG. 8 on the chunk list.

Referring to FIGS. 6 to 9, a plurality of chunks may constitute the chunk list, and a size of the newly allocated chunk may be the same as the previously allocated chunk (refer to FIG. 6) or larger than or equal to that of the previously allocated chunk (refer to FIG. 7).

The earliest allocated chunk is allocated with empty state (i.e., NULL state) of the corresponding chunk list. Thereafter, if a new chunk is allocated, the newly allocated chunk is positioned to a first position of the corresponding chunk list, and the previously allocated chunk is moved back. That is, the latest allocated chunk may be linked to the first position (i.e., highest position) of the corresponding list. And, the earliest allocated chunk may be linked to the last position (i.e., lowest position) of the corresponding list.

Therefore, in the case that the later allocated chunk is configured to be larger than or equal to the previously allocated chunk as illustrated in FIG. 7, the largest chunk may be linked to the first position (i.e., highest position) of the corresponding list, and the smallest chunk may be linked to the last position (i.e., lowest position) of the corresponding list. According to such configuration of the chunk list, when the memory requested by the application program 500 is allocated, the higher chunk (i.e., larger chunk) is allocated first. Accordingly, if the memory allocation and release operation is repeatedly performed in the first region 110 of the memory pool 100, the allocated memory finally converges to the largest chunk. The converging speed at the memory pool 100 may be varied according to the size of the chunk weight used for the chunk allocation.

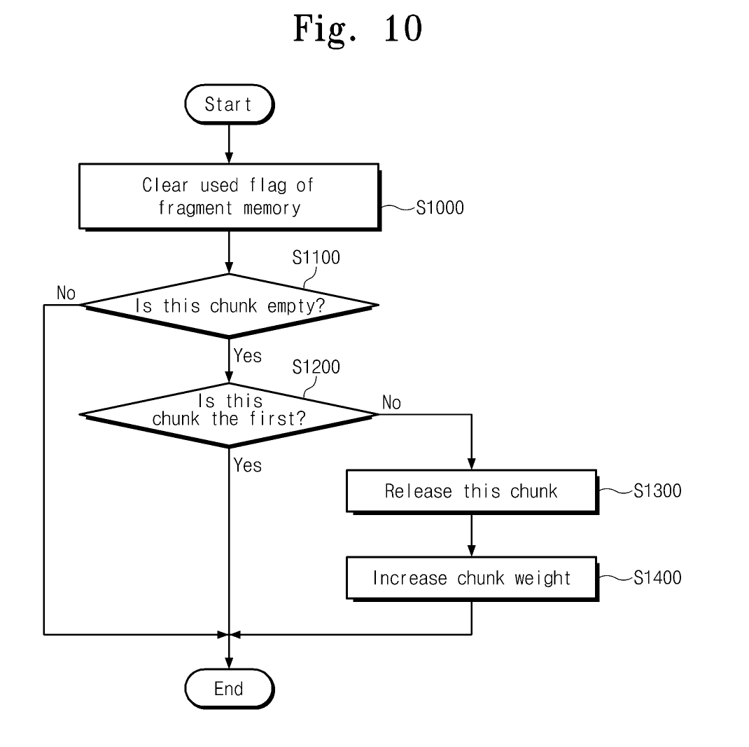

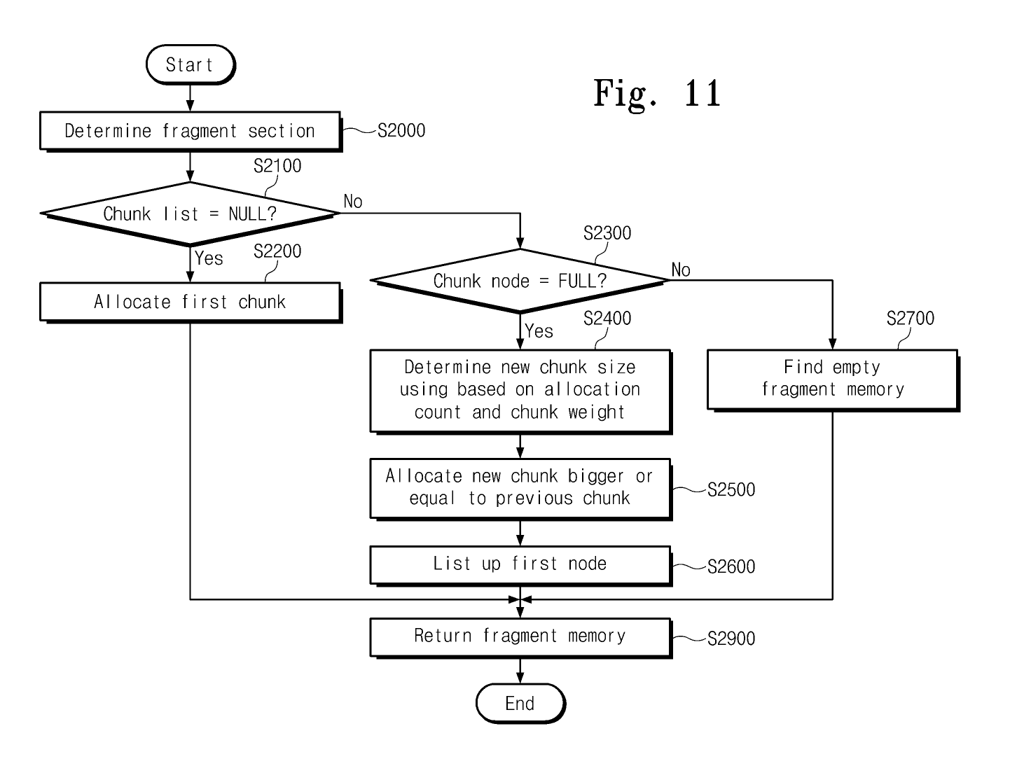

FIG. 10 is a flowchart illustrating a method for releasing memory according to a disclosed embodiment.

Referring to FIG. 10, for performing the memory release operation, the fragless module 200 may erase flag information of a memory fragment which is set as being used (operation S1000). Then, the fragless module 200 may determine whether the chunk which contains the corresponding memory fragment is empty (operation S1100).

According to a result of the determination at the operation S1100, if the chunk is not empty, the process is finished. And, if the chunk is empty according to the result of the determination at the operation S1100, the fragless module 200 may determine whether the corresponding chunk is the first chunk of the chunk list (operation S1200).

According to a result of the determination at the operation S1200, if the chunk is not the first chunk of the chunk list, the fragless module 200 may release the chunk from allocation (operation S1300), and increase the chunk weight (operation S1400). And, if the chunk is the first chunk of the chunk list according to the result of the determination at the operation S1200, the fragless module 200 may finish the process without releasing the first chunk from allocation even if the memory fragment allocated to the first chunk does not exist. That is, the first chunk of the chunk list may remain unchanged without being released from allocation even though all memory fragments are not being used. In this case, since the release operation has not been performed on the corresponding chunk, the chunk weight may keep its previous state without increase or decrease.

In FIG. 10, it is explained that the chunk weight used for chunk allocation is increased whenever the memory release operation is performed (refer to the operation S1400). However, this is just one disclosed embodiment, and the method of applying the chunk weight may be changed.

FIG. 11 is a flowchart illustrating the method of memory allocation.

Referring to FIG. 11, based on a size of the memory requested by the application program 500, the fragless module 200 may determine the fragment section in which the requested memory is included for performing the memory allocation operation (operation S2000). The memory requested by the application program 500 may be divided into the plurality of fragment sections according to the requested memory size as illustrated in FIG. 5. According to the fragment section requested, the size of the fragment memory and chunk to be used for allocating the requested memory may be determined.

Thereafter, the fragless module 200 may determine whether the chunk list corresponding to the fragment section determined at the operation S2000 is empty (NULL) (operation S2100). According to a result of the determination at the operation S2100, if the chunk list corresponding to the fragment section determined at the operation S2000 is empty, the fragless module 200 may allocate the first chunk to the corresponding chunk list (operation S2200). Then, the fragless module 200 may allocate the memory fragment in the allocated first chunk, and return the allocated memory fragment to the application program 500 (operation S2900).

According to the result of the determination at the operation S2100, if the chunk list corresponding to the fragment section determined at the operation S2000 is not empty, the fragless module 200 may determine whether all nodes of the corresponding chunk are full (FULL) (operation S2300).

According to a result of the determination at the operation S2300, if all nodes of the corresponding chunk are full, the fragless module 200 may increase an allocation count value (e.g., chunk allocation count value) which indicates the number of times of chunk allocation, and determine a chunk size to be newly allocated based on the allocation count value and the chunk weight (operation S2400). Then, the fragless module 200 may allocate a new chunk having the size determined at the operation S2400 to the corresponding chunk list (operation S2500). The chunk weight value applied at the operation S2400 may be configured to be increased whenever the allocation count value becomes a predetermined value (e.g., whenever the chunk allocation operation is performed predetermined number times). According to the chunk weight value determined in this manner, the size of the chunk to be newly allocated may be determined. The method of applying the chunk weight may be changed.

The size of the new chunk allocated at the operation S2500 may be configured to be larger than or equal to the previously allocated chunk. For instance, according to the chunk list configuration method according to one embodiment, the size of the new chunk may be configured to have the same size as the previously allocated chunk.

And, according to the chunk list configuration method, the size of the new chunk may be configured to be larger than or equal to the previously allocated chunk. The new chunk size may be configured to be increased whenever the chunk allocation operation is performed, or configured to be increased or keep the same size according to the chunk weight. For instance, in the case that the chunk weight applied to the previously allocated chunk and that applied to the currently allocated chunk are the same, the size of the new chunk may be configured to be same as the previously allocated chunk.

Thereafter, the fragless module 200 may set the new chunk allocated at operation S2500 as the first chunk of the chunk list (operation S2600). Then, the fragless module 200 may allocate the memory fragment in the allocated chunk, and return the allocated memory fragment to the application program 500 (operation S2900).

According to the result of the determination at the operation S2300, in the case that all nodes of the corresponding chunk are not full, the fragless module 200 may search a node to be allocated within the corresponding chunk (operation S2700). Then, the fragless module 200 may allocate the memory fragment in the allocated chunk, and return the allocated memory fragment to the application program 500 (operation S2900). According to one embodiment, the plurality of nodes included in the chunk may be sequentially searched from the first node to be allocated. And, the memory fragment used/unused information used_node for the allocated node may be stored into the header region as a flag.

The memory allocation method described referring to FIG. 11 may be applied to the chunk list configuration method of the disclosed embodiments. Also, the memory allocation method may be adaptively embodied combining the memory release method described referring to FIG. 10. The chunk list configuration method, the memory release method, and the memory allocation method to be applied to the memory management method may be variously changed and combined.

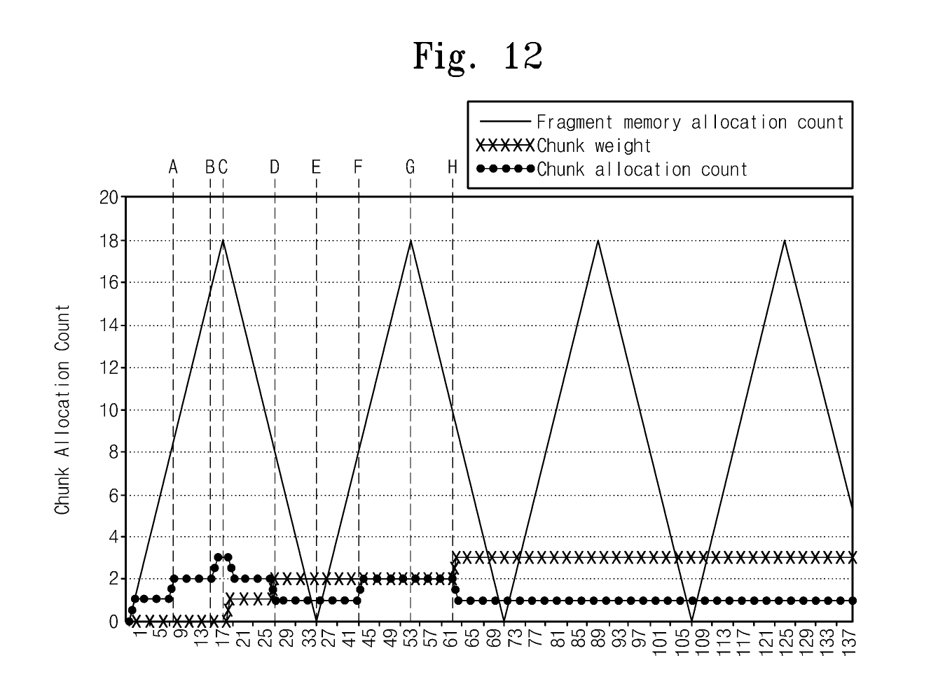

FIG. 12 is a diagram for explaining the memory allocation and release operation according to the disclosed embodiments.

In the case that 8 memory fragments are included in the chunk, the chunk weight value when 18 times of memory allocation operation and 18 times of memory release operation are successively performed, and a consequential result of chunk and memory fragment allocations are illustrated in FIG. 12. In FIG. 12, it is illustrated that the chunk weight is increased whenever the memory release operation is performed. In this case, the newly allocated chunk may be configured to have the same size as the previously allocated chunk or configured to be larger than the previously allocated chunk according to the chunk weight value.

Referring to FIG. 12, the method of applying the chunk weight is shown and may be completed in a variety of way. For instance, the chunk weight may be configured to be increased whenever the chunk allocation or release operation is performed, or whenever the chunk allocation operation or the chunk release operation is performed a predetermined number of times.

Also referring to FIG. 12, if the memory smaller than N bytes is requested by the application program 500, the fragless module 200 may perform the allocation operation to the memory fragment corresponding to the size of the memory requested by the application program 500. Whenever the memory allocation operation is performed in each memory fragment, the memory fragment allocation count value is increased by 1. In this case, the chunk allocation count value is set as 1, and the chunk weight has a value of 0.

Again, referring to FIG. 12, if the allocation operation for 8 memory fragments included in a first chunk is completed from 0 to a time point A, a second chunk is newly allocated and the chunk allocation count value is increased from 1 to 2. If the allocation operation for 8 memory fragments included in the second chunk is completed from the time point A to a time point B, a third chunk is newly allocated and the chunk allocation count value is increased from 2 to 3.

The size of the newly allocated chunk may be determined by the chunk weight value. However, since the memory release operation is not performed from 0 to a time point C, the chunk weight maintains a value of 0 from 0 to the time point C. Accordingly, the second and third chunk newly allocated between 0 and the time point C may have the same size as the previously allocated first chunk.

Again, continuing to refer to FIG. 12, after the allocation operation is performed to 2 memory fragments at the third chunk from the time point B to the time point C, if the memory release operation is started, the memory fragment allocation count value is decreased whenever the memory release operation is performed. And, the chunk count value is decreased from 3 to 2 and the chunk weight value is increased from 0 to 1. According to one embodiment, the chunk count value may be decreased to 2 at a time point where the memory release operation is successively performed twice from the time point C, e.g., at a time point where the third chunk is released.

Again, continuing to refer to FIG. 12, if the memory release operation is additionally performed 8 times from the time point C to a time point D and thus the second chunk is released, the memory fragment allocation count value is successively decreased by 8 and the chunk count value is decreased from 2 to 1. And, the chunk weight value is increased from 1 to 2.

Again, continuing to refer to FIG. 12, when the memory release operation is performed 8 times from the time point D to a time point E, only one chunk, i.e., the first chunk, remains in the chunk list. In this case, the first chunk of the chunk list may be configured not to be released even if all 8 memory fragments provided to the first chunk are released. Accordingly, the chunk count value keeps the value of 1, and the chunk weight value also keeps the value of 2.

Thereafter, again, continuing to refer to FIG. 12, in the case that the memory allocation is performed 8 times from the time point E to a time point F, the memory allocation is performed to 8 memory fragments provided to the empty first chunk. In this case, since a new chunk is not allocated for the memory fragment allocation, the chunk allocation count value still keeps the value of 1. And, in this case, since the memory release operation is not performed, the chunk weight value also keeps the value of 2.

Again, continuing to refer to FIG. 12, in the case that the memory allocation is performed 8 times from the time point F to a time point G, a fourth chunk may be additionally allocated. In this case, since the new chunk is allocated for the memory fragment allocation, the chunk allocation count value is increased from 1 to 2. And, in this case, since the memory release operation is not performed, the chunk weight value keeps the value of 2.

A size of the newly allocated fourth chunk may be determined by the chunk weight value. According to the embodiment, the size of the fourth chunk may be configured to have a value of the size of the first chunk multiplied by 2^{chunk}^{_{—}}^{weight} (new chunk size=previous chunk size×2^{chunk}^{_{—}}^{weight}). For instance, since the chunk weight corresponding the time point F to the time point G has the value of 2, the size of the fourth chunk may be four times (i.e., 2² times) larger than that of the first chunk. That is, in the case that the first chunk includes 8 memory fragments each having 256 bytes, the fourth chunk may be configured to include 32 memory fragments each having 256 bytes. In this case, the newly allocated fourth chunk may be positioned to the first position of the corresponding chunk list. At the period from the time point F to the time point G, the memory allocation operation is performed to 8 memory fragments in the newly allocated fourth chunk.

Again, continuing to refer to FIG. 12, in the case that the memory release operation is performed 8 times from the time point G to a time point H, the 8 memory fragments included in the first chunk may be firstly released, and the first chunk may be released at the time point H. Since there is no change for the allocated chunk from the time point G to the time point H, the chunk allocation count value keeps the value of 2. And, if the first chunk is released at the time point H, the chunk allocation count value is decreased from 2 to 1, and the chunk weight value is increased from 2 to 3.

Again, continuing to refer to FIG. 12, after the time point H, the memory allocation and release operation may be repeatedly performed through the fourth chunk positioned at the first position of the chunk list. In this case, since the fourth chunk may be configured to be larger than the first chunk, the number of memories to be allocated and released within the fourth chunk is larger than that of the first chunk. Accordingly, after the time point H, all the memory allocation and release operations for the memories requested by the application program 500 may be performed within the fourth chunk without allocating additional chunks.

According to the described embodiment, the plurality of chunks allocated and released are within the same chunk list. However, this is just one embodiment, and the memory allocation and release operation may be performed on a plurality of chunk lists according to the size of the requested memory.

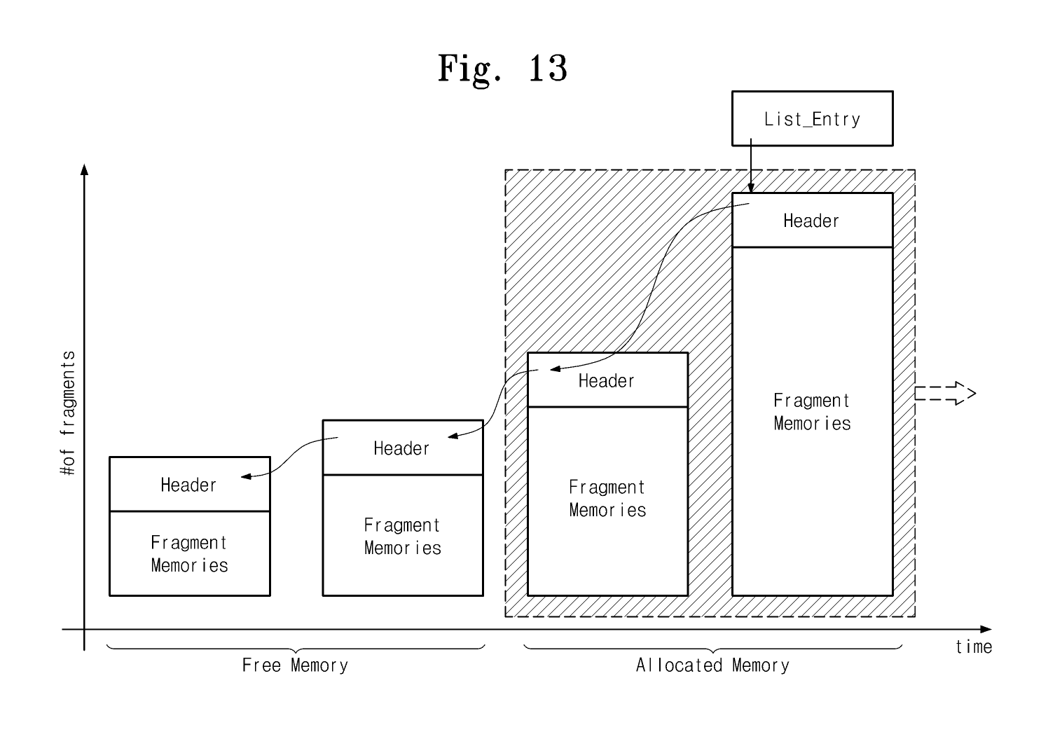

FIG. 13 is a diagram illustrating a convergence process of the memory pool 100 according to the memory allocation and release operations.

Referring to FIG. 13, if the memory allocation and release operation is repeatedly performed to memories smaller than predetermined bytes through the fragless module 200, the allocation operation may be repeatedly performed to a larger chunk than a previously allocated chunk. As a result, the recently allocated large chunk may be positioned at a higher position of the chunk list, and the previously allocated small chunk may be positioned at a lower position of the chunk list. In this case, each chunk may point to the next chunk through the header.

Referring to FIG. 13, according to this chunk list configuration, the memory fragment allocation operation may be initially performed at the largest chunk. Therefore, as the number of times of the memory allocation and release operation is increased, the memory release operation is mainly performed at the small chunk and the memory allocation operation is mainly performed at the large chunk. Accordingly, if the number of times of the memory allocation and release operation is increased, the actually allocated and released chunk finally converges to the first positioned chunk of the chunk list. According to the described embodiment, since the chunk may gradually converge from the smaller chunk to the large chunk according to the frequency of the memory allocation, applicability of the memory pool 100 may be improved, and fragmentation of the memory pool 100 may be prevented.

FIG. 14 is a diagram illustrating the converging speed of the memory pool 100 according to the chunk weight value.

Referring to FIG. 14, the chunk weight may be configured to be increased or decreased according to the number of times of performing the chunk allocation or release operation. In FIG. 14, a first algorithm (Algorithm1) indicates the configuration where the chunk weight is increased whenever the memory allocation or release operation is performed k (k is a positive integer) times. A second algorithm (Algorithm2) indicates the configuration where the chunk weight is increased whenever the chunk allocation or release reaches a predetermined weight. A third algorithm (Algorithm3) indicates the configuration where the chunk weight is increased whenever the chunk allocation or release reaches a double of the predetermined weight (chunk_weight×2). And, a fourth algorithm (Algorithm4) indicates the configuration where the chunk weight is increased whenever the chunk allocation or release reaches a square of the predetermined weight (chunk_weight²).

In FIG. 14, the chunk weight value may be configured so that its size has an order of the first algorithm<the second algorithm<the third algorithm<the fourth algorithm. In this case, the converging speed of the memory pool has an order of the first algorithm>the second algorithm>the third algorithm>the fourth algorithm. That is, the larger the size of the chunk weight value is, the slower the converging speed of the memory pool is. The faster the converging speed is, the lower the utilization of the memory pool 100 is. The slower the converging speed is, the higher the utilization of the memory pool 100 is. Therefore, for improving efficiency of memory use, the chunk weight may be determined as an optimum value considering the memory utilization and converging speed.

FIG. 15 is a diagram illustrating the number of times of memory allocation call and a corresponding amount of required memory which are possibly generated at the time of horizontal scroll.

In FIG. 15, a graph marked by first embodiment indicates the number of times of memory allocation call and the corresponding amount of required memory when the chunk list configuration method shown in FIG. 6 is applied. The first embodiment may correspond to the case of not applying the chunk weight. And, a graph marked by second embodiment indicates the number of times of memory allocation call and the corresponding amount of required memory when the chunk list configuration method of FIG. 7 is applied. The second embodiment may correspond to the case of applying the chunk weight.

In Table 1 below, the number of times of memory allocation call and the corresponding amount of required memory according to the number of times of horizontal scroll are shown corresponding to the first and second embodiments illustrated in FIG. 15. Also, the number of times of memory allocation call and the corresponding amount of required memory in the case of not providing the fragless module 200 are also shown in Table 1 (refer to No Fragless of Table 1).

TABLE 1

| The number of times of | | | |
|---|---|---|---|
| memory allocation call when | | First | Second |
| horizontal scroll occurs once | No Fragless | Embodiment | Embodiment |
| #1 | 3,500 | 106 | 21 |
| #2 | 5,047 | 122 | 24 |
| #3 | 5,869 | 148 | 24 |
| #4 | 7,412 | 166 | 24 |
| #5 | 8,609 | 177 | 24 |
| #6 | 10,510 | 191 | 24 |
| #7 | 11,432 | 218 | 24 |
| #8 | 12,642 | 228 | 24 |
| Memory allocation size | 1,648,667 | 794,291 | 1,434,208 |

Referring to FIG. 15 and Table 1, in the case of not applying the fragless module 200, the number of times of memory allocation call is very high in comparison with the first and second embodiments. In this case, the size of the allocated memory is also remarkably large in comparison with the first and second embodiments. This may mean that lots of additional data are required in the case of not applying the fragless module 200 to the memory allocation in comparison with the disclosed embodiments. As the size of the memory used for the memory allocation becomes larger, the utilization of the memory pool 100 becomes lower.

On the contrary, according to the first and second embodiments, the allocation and release operation for the memory smaller than a predetermined size (e.g., N bytes) may be internally performed within one region (e.g., the first region 110) of the memory pool 100 through the fragless module 200 without process of the heap 300. Accordingly, the number of times of memory allocation call is remarkably reduced in comparison with the case of not applying the fragless module 200. Also, according to the first and second embodiments, the allocation and release for the memory smaller than the predetermined size (e.g., N bytes) do not occur in the memory pool 100, and thus fragmentation of the memory pool 100 is efficiently prevented.

Particularly, in the case of the first embodiment where the chunk weight is not applied, the size of the memory used for the memory allocation is very small. And, in the case of the second embodiment where the chunk weight is applied, the size of the memory used for the memory allocation is large in comparison with the first embodiment, but the number of times of memory allocation request is very small. The chunk list configuration method according to the first and second embodiments may be adaptively embodied for the memory allocation and release method so that the number of times of memory allocation call and the corresponding amount of required memory are optimized.

FIG. 16 is a diagram illustrating a user device 2000 according to another embodiment.

Referring to FIG. 16, the user device 2000 may be applicable to mobile computers, Ultra Mobile PCs (UMPCs), work stations, net-books, PDAs, portable computers, web tablets, wireless phones, mobile phones, smart phones, digital cameras, digital audio recorders, digital audio players, digital picture recorders, digital picture players, digital video recorders, digital video players, devices capable of transmitting/receiving information in wireless environments, and one of various electronic devices constituting a home network. Also, the user device 2000 may be configured as an embedded system. The RTOS or mobile OS may be applied to the user device 2000 for light weight and high operational speed of the system. Particularly, the OS may not support a garbage collection function.

The user device 2000 may include a host 2900 and a storage device 2300.

The host 2900 may include a processing unit 2100 electrically connected to a system bus, a memory 2200, a user interface 2400, and a modem 2500 such as a baseband chipset. The host 2900 may perform interfacing with an external device through the user interface. The user interface 2400 may support at least one of various interface protocols such as USB, MMC, PCI-E, SAS, SATA, PATA, SCSI, ESDI, and IDE.

The memory 2200 may include various types of memories, e.g., the volatile memory such as DRAM and SRAM, and the nonvolatile memory such as EEPROM, FRAM, PRAM, MRAM, and flash memory. The memory 2200 illustrated in FIG. 16 may be configured to have the substantially same structure as the memory 1200 illustrated in FIG. 3. Therefore, the previous explanations for the same configuration will be omitted below.

The memory 2200 may include one or more general-purpose memory devices for storing the OS and application program for operating the user device 2000 and data. The user device 2000 may prevent fragmentation of the memory pool 100 through the fragless module 200 even if the OS does not support the garbage collection function. In the embodiment, the memory allocation and release operation for a memory smaller than N bytes (e.g., 32,768 bytes) may be internally performed through the fragless module 200 without process of the heap. As a result, the allocation and release of memory smaller than the predetermined size (e.g., N bytes) does not additionally occur in the memory pool 100, and thus fragmentation of the memory pool 100 is prevented. The above-described memory management method may be applied to various operating systems without being limited to a particular operating system.

The storage device 2300 may constitute a memory card, a USB memory, a Solid State Drive (SSD), or a Hard Disk Drive (HDD). The storage device 2300 may include a host interface 2310 and a main storage 2350. The host interface 2310 may be connected to the system bus and provide a physical connection between the host 2900 and the storage device 2300. The storage device 2300 may perform interfacing with the main storage 2350 through the host interface 2310 which supports a bus format of the host 2900. For instance, the host interface 2310 may support at least one of various interface protocols such as USB, MMC, PCI-E, SAS, SATA, PATA, SCSI, ESDI, and IDE. The configuration of the host interface 2310 may be changed and is not limited to a particular configuration. The main storage 2350 may be provided as a multi-chip package including a plurality of flash memory chips. The main storage 2350 may include the volatile memory such as DRAM and SRAM, and the nonvolatile memory such as EEPROM, FRAM, PRAM, MRAM, and flash memory.

In the case that the user device 2000 is a mobile device such as a laptop computer and a cell phone, a battery 2600 may be additionally provided for supplying power to the user device 2000. Although not illustrated in the drawing, the user device 2000 may be further provided with a Camera Image Processor (CIS), a mobile DRAM, and the like.

Also, the user device 2000 may be mounted in various types of packages, e.g., Package on Package (PoP), Ball Grid Arrays (BGA), Chip Scale Packages (CSP), Plastic Leaded Chip Carrier (PLCC), Plastic Dual In-line Package (PDIP), Die in Waffle Pack, Die in Wafer Form, Chip On Board (COB), Ceramic Dual In-line Package (CERDIP), Plastic Metric Quad Flat Pack (MQFP), Thin Quad Flat Pack (TQFP), Small Outline Integrated Circuit (SOIC), Shrink Small Outline Package (SSOP), Thin Small Outline Package (TSOP), System In Package (SIP), Multi Chip Package (MCP), Wafer-level Fabricated Package (WFP), and Wafer-level Processed Stack Package (WSP). These package mounting characteristics may be applied to not only the user device 2000 illustrated in FIG. 16 but also the user device 1000 illustrated in FIG. 2 and FIG. 3.

As shown in the described embodiments, in an OS environment where the garbage collection function is not supported, memory fragmentation in the memory pool can be effectively prevented and limited resources of the embedded system can be efficiently used.

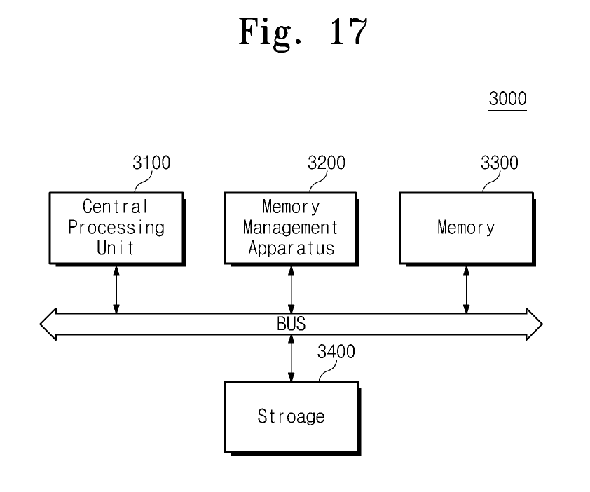

Referring to FIG. 17, the user device 3000 may be applicable to mobile computers, Ultra Mobile PCs (UMPCs), work stations, net-books, PDAs, portable computers, web tablets, wireless phones, mobile phones, smart phones, digital cameras, digital audio recorders, digital audio players, digital picture recorders, digital picture players, digital video recorders, digital video players, devices capable of transmitting/receiving information in wireless environments, and one of various electronic devices constituting a home network. Also, the user device 3000 may be configured as an embedded system. The RTOS or mobile OS may be applied to the user device 3000 for light weight and high operational speed of the system. Particularly, the OS may not support a garbage collection function.

The user device 3000 may include a central processing unit (CPU) 3100, a memory management apparatus 3200, a memory 3300 and storage 3400.

The CPU 3100 electrically connects to a system bus, a memory management apparatus 3200, a memory 3300 and storage 3400.

The memory 3300 may include various types of memories, e.g., the volatile memory such as DRAM and SRAM, and the nonvolatile memory such as EEPROM, FRAM, PRAM, MRAM, and flash memory. The memory 3300 illustrated in FIG. 17 may be configured to have the substantially same structure as the memory 1200 illustrated in FIG. 3. Therefore, the previous explanations for the same configuration will be omitted below.

The memory 3300 may include one or more general-purpose memory devices for storing the OS and application program for operating the user device 3000. The user device 3000 may prevent fragmentation of the memory pool 100 through the memory management apparatus 3200 even if the OS does not support the garbage collection function. In the embodiment, the memory management apparatus 3200 controls the allocation and release operations for a memory smaller than N bytes (e.g., 32,768 bytes) through the fragless module 200 shown in FIG. 2 without the use of the heap. As a result, the allocation and release of memory smaller than the predetermined size (e.g., N bytes) does not additionally occur in the memory pool 100 also shown in FIG. 2, and thus fragmentation of the memory pool 100 is reduced and/or prevented. The above-described memory management apparatus 3200 may be used with various operating systems without being limited to a particular operating system.

The storage device 3400 may constitute a memory card, a USB memory, a Solid State Drive (SSD), or a Hard Disk Drive (HDD).

Also, the user device 3000 may be mounted in various types of packages, e.g., Package on Package (PoP), Ball Grid Arrays (BGA), Chip Scale Packages (CSP), Plastic Leaded Chip Carrier (PLCC), Plastic Dual In-line Package (PDIP), Die in Waffle Pack, Die in Wafer Form, Chip On Board (COB), Ceramic Dual In-line Package (CERDIP), Plastic Metric Quad Flat Pack (MQFP), Thin Quad Flat Pack (TQFP), Small Outline Integrated Circuit (SOIC), Shrink Small Outline Package (SSOP), Thin Small Outline Package (TSOP), System In Package (SIP), Multi Chip Package (MCP), Wafer-level Fabricated Package (WFP), and Wafer-level Processed Stack Package (WSP). These package mounting characteristics may be applied to not only the user device 3000 illustrated in FIG. 17 but also the user device 1000 illustrated in FIG. 2 and FIG. 3.

As shown in the described embodiments, in an OS environment where the garbage collection function is not supported, memory fragmentation in the memory pool can be effectively prevented and/or reduced, and limited resources of the embedded system can be efficiently used by use of the embodiments described herein.

The above-disclosed subject matter is to be considered illustrative and not restrictive, and the claims are intended to cover all such modifications, enhancements, and other embodiments. Thus, to the maximum extent allowed by law, the scope is to be determined by the broadest permissible interpretation of the following claims and their equivalents, and shall not be restricted or limited by the foregoing detailed description.

What is claimed is:

1. A method for managing a memory, comprising:
dividing a memory into a first region and a second region;
allocating memory larger than N bytes within the second region;
releasing memory larger than N bytes within the second region;
allocating memory smaller than or equal to N bytes though a fragless module within the first region;
releasing memory smaller than or equal to N bytes through a fragless module within a first region.

2. The method of claim 1, wherein the performance of allocating memory and releasing memory larger than N bytes is processed within a heap.

3. The method of claim 1, wherein the performance of allocating memory and releasing memory smaller than or equal to N bytes comprises:
determining the memory fragment among a plurality of memory fragments based on the size of the requested memory;
determining the size of the memory fragment as the maximum value of the requested memory;
allocating a first chunk wherein the first chunk is M times larger than the size of the memory fragment; and
allocating the memory corresponding to the requested memory within the first chunk;
releasing the memory fragment among a plurality of memory fragments.

4. The method of claim 3, wherein the fragments are divided into different sizes within range of N bytes.

5. The method of claim 3, wherein the first chunk comprises M numbers of memory fragments.

6. The method of claim 3, further comprising the allocation of a second chunk when the first chunk does not contain any empty memory fragments.

7. The method of claim 6, wherein the second chunk is larger than or equal to the first chunk.

8. The method of claim 6, wherein the size of the second chunk is based on at least one of the following:
a number of previously performed allocations;
a number of previously performed releases; and
a chunk weight.

9. The method of claim 6, wherein the chunk weight is increased when the second or subsequent chunks are allocated or when the second chunk is successively allocated in excess of a set number of times.

10. The method of claim 6, wherein the first, second and subsequent chunks are included in a chunk list.

11. The method of claim 10, wherein the final chunk is configured to be located at the highest position of the chunk list.

12. The method of claim 11, wherein the requested memory is allocated within the chunk at the highest position of the chunk list.

13. A method for managing a memory, comprising:
dividing a memory into a first region and a second region;
allocating memory larger than N bytes within the second region;
releasing memory larger than N bytes within the second region;
allocating memory smaller than or equal to N bytes though a fragless module within the first region;
releasing memory smaller than or equal to N bytes through a fragless module within a first region;
wherein the performance of allocating memory and performance of releasing memory for the memory smaller than or equal to N bytes further comprises:
removing flag information of a memory fragment corresponding to a memory requested to be released;
determining whether an empty chunk is configured to be on the highest position of the chunk list;
releasing the empty chunk from the chunk list if the empty chunk is not on the highest position of the chunk list; and
increasing the chunk weight.

14. The method of claim 13, wherein the flag information is stored in a header of the corresponding chunk.

15. The method of claim 13, further comprising maintenance of the empty chunk on the chunk list when the empty chunk is on the highest position of the chunk list.

16. The method of claim 13, wherein the chunk weight is incremented when the empty chunk is released from the chunk list or wherein the empty chunk is successively released from the chunk list more than a predetermined number of times.

17. A method for managing memory, comprising:
determining the memory fragment among a plurality of memory fragments if the requested memory is smaller than or equal to N bytes and therefore allocated through a fragless module;
determining the size of the memory fragment as the maximum value of the requested memory;
allocating a first chunk in one region of the memory when the first chunk is M times larger than the size of the memory fragment; and
allocating the memory corresponding to the requested memory within the first chunk.

18. The method of claim 18, further comprising the allocation of a second or subsequent chunk larger than or equal to the first or previously allocated chunks when no empty memory fragment exists within the first or previously allocated chunks.

19. An apparatus for managing memory, comprising:
a control unit to manage the allocation and release of memory larger than N bytes through a heap and to manage the allocation and release of memory smaller than or equal to N bytes through a fragless module;
wherein the memory allocated and the memory released through the fragless module is within a first region of memory and the memory allocated and the memory released through the heap is within a second region of memory.

20. An apparatus of claim 19, wherein the control unit can be implemented in hardware, software or a combination of hardware and software.
